(19) United States
(12) Patent Application Publication
(10) Pub. No.: US 2008/0175400 A1
(43) Pub. Date: Jul. 24, 2008

(54) COMM-CHECK SURROGATE FOR COMMUNICATIONS NETWORKS

(76) Inventor: Nathaniel M. Napoletano, Akron, OH (US)

Correspondence Address: WELSH & KATZ, LTD, 120 S RIVERSIDE PLAZA, 22ND FLOOR, CHICAGO, IL, 60606, US

(21) Appl. No.: 11/971,303

(22) Filed: Jan. 9, 2008

Related U.S. Application Data
(60) Provisional application No. 60/886,396, filed on Jan. 24, 2007.

(51) Int. Cl. H04R 29/00

(52) U.S. Cl. 381/58

(57) ABSTRACT

A test system includes an instrumented mannequin head coupled to measurement and control circuits. The instrumented head can be located at a test site. Audio from a communications system emitted by a helmet placed on the instrumented head can be evaluated and the system repaired or adjusted for improved performance at the test site.

### CROSS-REFERENCE TO RELATED APPLICATION

This application claims the benefit of the filing date of U.S. Provisional Application Ser. No. 60/886,396 filed Jan. 24, 2007 and entitled “Comm-Check Surrogate for Communications Networks”. The '396 application is hereby incorporated by reference.

### FIELD

The invention pertains to instrumented test tools for voice communications systems. More particularly, the invention pertains to such systems which include a multi-function mannequin to sense and emit audio outputs.

### BACKGROUND

Currently networked voice communications systems are tested by human technicians with a minimum of specialized tooling. During system alignment, testing, or fault diagnosis, several types of actions are required that are difficult to perform with human operators at the local and remote communications stations. Additionally, known processes are labor intensive.

Sustained tones are needed as references for gain measurements. Currently a synthetic tone is injected into the signal path at some convenient test point bypassing the human-worn communications gear. End-to-end system testing is not accomplished by this method. End-to-end system testing is then performed by technicians or pilots wearing the communications gear. This method is often inaccurate. The problems are then as follows:

Injected synthetic reference tones bypass the human-worn communications gear (often aged and faulty) and possibly other critical components in the signal path. This makes testing incomplete. End-to-end system testing is not accomplished by this method.

To compensate for the above technicians or pilots use of their voices to inject test signals into communications microphones and use of their hearing to evaluate the signal strength and fidelity. This method is subjective and often inaccurate.

Technicians and pilots asked to perform oral signal generation are often reluctant and unable to produce sustained voice signals for the length of time required to make measurements and diagnose faults.

A class of faults called intermittent faults diminishes the stability of a system and may require days of testing to diagnose. Technicians are limited in how many tests per hour they can perform without a fast and highly compliant machine responding to commands at the remote stations.

Technicians performing manual measurement operations create no opportunity to employ labor-saving automation.

There is thus a continuing need for voice communications test tools. Preferably results could be reported over the same voice network without any need for supplemental or test connections.

### BRIEF DESCRIPTION OF THE DRAWINGS

FIG. 1 is a block diagram of one embodiment of the invention;

FIG. 2 is a block diagram of additional details of the embodiment of FIG. 1;

FIG. 3 is a block diagram illustrating relationships with a system under test;

FIG. 4 is a block diagram of a multi-site embodiment of the invention; and

FIG. 5 illustrates a test and evaluation instrument in accordance with the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In accordance with the invention, a test and evaluation instrument or tool is placed at a voice communications station, such as a simulated cockpit or instructor's station. The instrument facilitates communications system network alignment and testing.

Embodiments of the invention replace a human operator at a communications station under test. This results in superior precision, lower cost, uninterrupted service and better cooperation than achieved with a human tester.

In one aspect, a mannequin head, or surrogate, with microphonic ears and sound pressure producing mouth orifice is provided. The head can wear any human-worn headset or helmet.

A programmable processor and interface circuitry can be located inside of the surrogate. Such circuitry and software are capable of automating many of the repetitive tasks involved in system alignment, testing and fault diagnosis. They are capable of performing types of stability testing that are currently impossible.

The present system measures and provides precise reference tones used to align a communications system network. It reports results over the same voice network with no need for an additional data connection. It is inserted into a communications network at a remote station under test.

The test base station uses test equipment to excite and command the remotely located surrogate. Measurements can be made at the local and remote base stations. The results of the measurements are used to create alignment adjustments, acceptance test results, diagnostic recommendations, and stability assessment results.

The aforementioned problems, noted in the Background Section are solved as follows:

Injected synthetic reference tones making testing incomplete are replaced with end-to-end stimulus and measurement using the exact equipment worn by the pilot. A technician's or a pilot's voice is replaced with accurate reference tones. Test tones can be sustained indefinitely.

Embodiments of the invention are highly responsive and can perform tests at a rate that outpaces the productivity of a technician armed with conventional test equipment.

In yet another aspect of the invention, the mannequin head contains two reference microphones for ears and one reference annunciator for simulated oral emissions. A headset/helmet under test is placed on mannequin head. A reference tone from the headset under test is monitored by the at least one microphone, pre-amplified and measured by measured by measurement electronics. A microcontroller, local or remote can record test results using a data logger. A tone generator creates a reference tone that is amplified and played through an annunciator into a microphone in a headset/helmet under test. Push-to-talk and other controls are activated as necessary by a local or remotely located control activator.

A user can control and observe the surrogate using a user control/display. The user can control and observe the comm check surrogate through a computer interface. The user can control local and remote comm. check surrogate systems using a commands his local control/display. The commanding comm. check surrogate system can send commands using its tone generator. The subordinate comm. check surrogate system receives commands through its tone decoder and responds accordingly. Commands can be similarly sent from the base station.

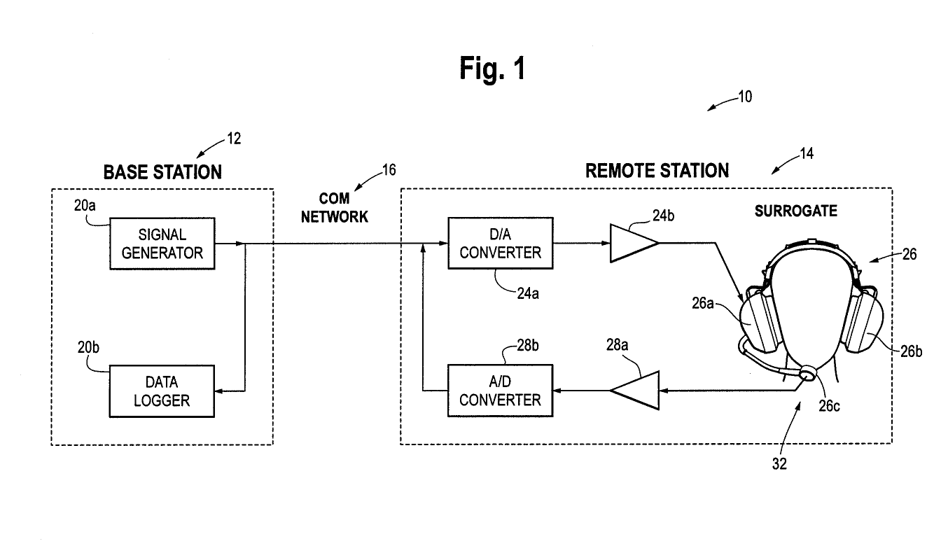

FIG. 1 illustrates a system 10 which embodies the present invention. System 10 includes a base station 12, a remote station 14 and a communication network 16 which couples the two stations together and provides for voice communication therebetween.

Base station 12 includes a test signal generator 20a as well as a data logger 20b both of which are coupled to the network 16. Remote station 14 includes a digital-to-analog converter 24a with analog output signals is coupled to at least an amplifier 24b.

Analog outputs from the amplifier 24b, corresponding to voice or audible tones received via the communications network 16 from base station 12 are coupled to a headset 26. Headset 26 includes first and second audio output transducers 26a,b and a microphone 26c.

In normal operation headset 26 would be worn by a pilot or other individual who might, for example, be engaged in a training exercise in connection with operating an aircraft or other type of vehicle. That individual would receive voice and/or other audible communications via the transducers 26a,b which originated at base station 12. Microphone 26c would be used by that individual to communicate via an amplifier 28a which is in turn coupled to analog-to-digital converter 28b whose output is transmitted via communication network 16 to base station 12.

In accordance with the invention, and for purposes of adjusting and aligning the stations 12, 14 the pilot or other individual participating in a training exercise is replaced with an instrumented surrogate or a mannequin indicated generally at 32. Headset 26 is mounted on the instrumented surrogate 32 for test and alignment purposes.

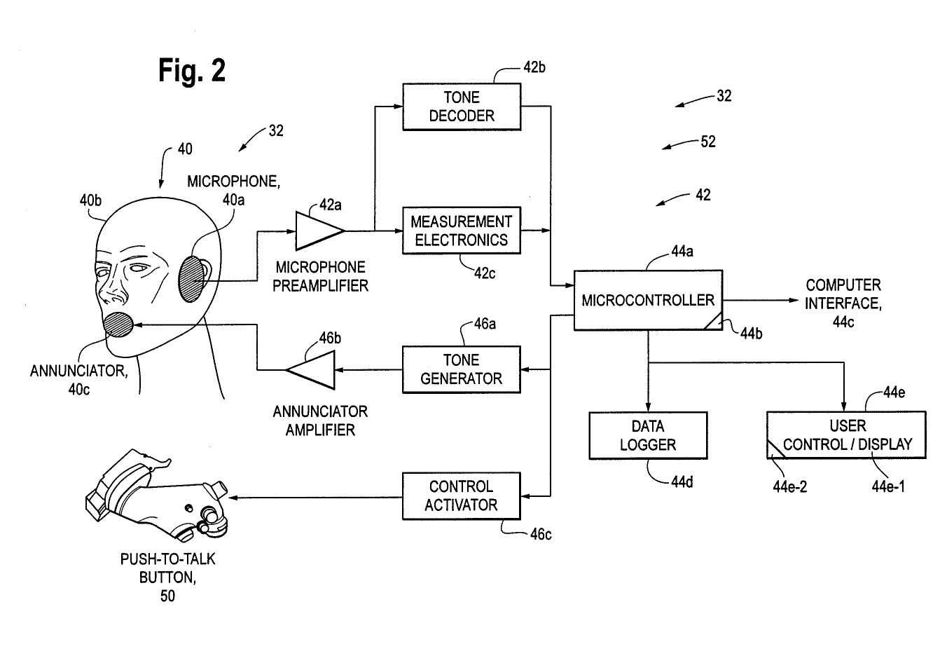

Possible test procedures which include using the surrogate 32 include generating audible test signals or tones via signal generator 20a, transmitting same via network 16 to the transducers 26a,b. Output from the transducers 26a,b is coupled to microphones, best seen in FIG. 2.

Amplitude, phase or other parameters of received audio sensed at the surrogate 32 can be monitored and evaluated. Such outputs can also be used for purposes of adjusting or aligning the stations 12, 14 for optimal performance. Surrogate 32, as discussed in more detail subsequently, can be equipped with an audio output transducer to couple test audio via microphone 26c to data logger 20b of base station 12 for analysis.

FIG. 2 illustrates additional details of the instrumented surrogate or mannequin 32. Mannequin 32 can include a head-like structure 40 upon which the headset 26 is mounted for test and alignment purposes.

Element 40 carries first and second spaced apart microphones 40a,b positioned so as to receive audio signals from transducers 26a,b. Element 40 carries an audio annunciator 40c which can be used to generate test audio output signals to be coupled to microphone 26c for transmission to base station 12.

Audio outputs received via microphone 40a can be coupled to a microphone pre-amplifier 42a. Amplified outputs from the pre-amplifier 42a can in turn be coupled to a tone decoder 42b and measurement electronics 42c.

Outputs from the tone decoder 42b and electronics 42c can be coupled to a programmable processor such as 44a which, as those of skill in the art will understand, could be operating in conjunction with pre-stored control software 44b. The control software 44b could be stored on a computer readable medium including read-only memory, read-write memory, all without limitation. Such memory elements could be implemented as semi-conductor and/or magnetic storage elements, such as disk drives, all without limitation.

Microcontroller or processor 40a can in turn communicate via a computer interface 44c with one or more local computer all without limitation. Outputs from microcontroller 44a can be coupled to a data logger 44d for purposes of generating hard copy and/or a user output device 44e which could include a graphical display device 44e-1 and a keyboard for control purposes 44e-2.

A tone generator 46a and associated amplifier 46b can be coupled to the microcontroller 44a as well as to the annunciator 40c for purposes of generating test tones to be coupled to the microphone 26c. In addition, depending on the hardware requirements of the type of unit with which the instrument and surrogate 32 is being used, a control activator, for example an electrically operated solenoid, 46c can be coupled to an output of the microcontroller 44a.

The control activator 46c can, in turn when energized by the microcontroller 44a, position a push-to-talk button 50 of the associated equipment in a “talk” state such that tones or other audio test signals emitted by annunciator 40c can in turn be transmitted via microphone 26c and network 16 to base station 12.

As those of skill in the art will understand, the electronics 52 for the instrumented surrogate 32 can be in-part located within the head 40 and/or in-part located adjacent thereto, all without limitation. Those of skill in the art will also understand that the audio channel including amplifier 42 decoder 42b and measurement electronics 42c can be replicated for microphone 40b as a second audio output channel. That second audio output channel which receives signals from microphone 40b can in-turn have outputs coupled to the microcontroller 44a as is the case for the audio channel 42 associated with microphone 40a.

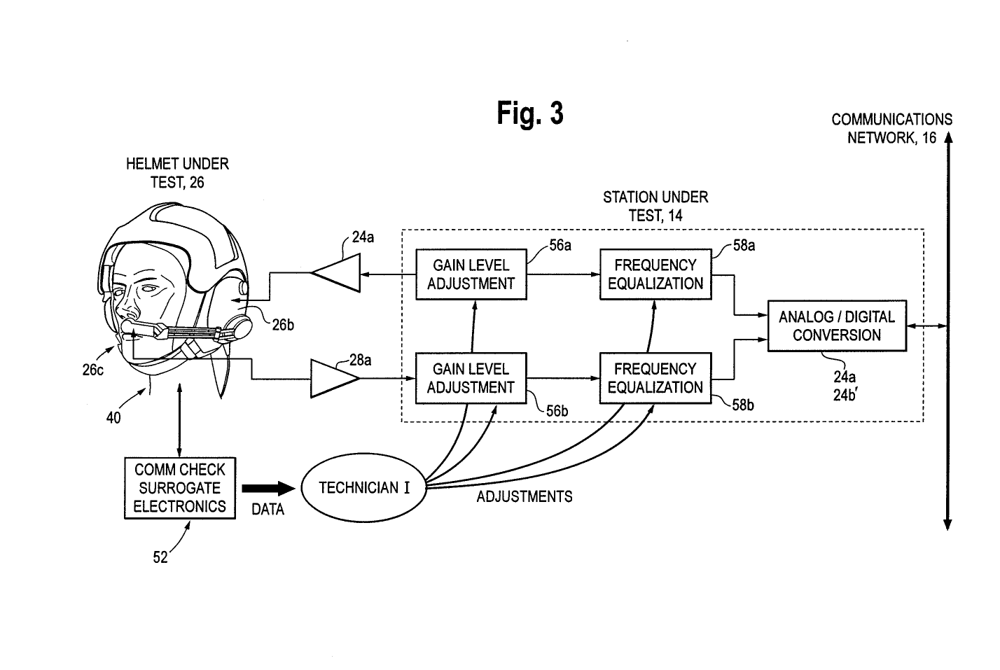

FIG. 3 illustrates additional aspects of embodiments of the present invention. As illustrated in FIG. 3 a helmet 26 under test can be mounted on the mannequin unit 40. Output transducers 26a,b can in-turn be coupled to audio outputs from amplifier 24b. Outputs from microphone 26c generated by transducer 40c can be coupled to input amplifier 28a.

A technician T at the station 14 can review via a data logger 44d or control and output device 44e analysis of signals received at the instrumented surrogate 32 from base station 12 to assess, for example, received amplitude levels. Similarly, gain of outputs generated by surrogate electronics 52 and sensed at microphone 26c can be evaluated.

Technician T can adjust gain parameters associated with both incoming and outgoing audio 56a,b. Frequency equalization can also be adjusted via elements 58a,b. Adjusted inputs can be received via communications network or system 16. Adjusted outputs can be coupled to communications network 16 for receipt by base station 12. Those of skill in the art will understand that the elements of remote station 14 illustrated in FIG. 3 are exemplary only and not limitations of the present invention.

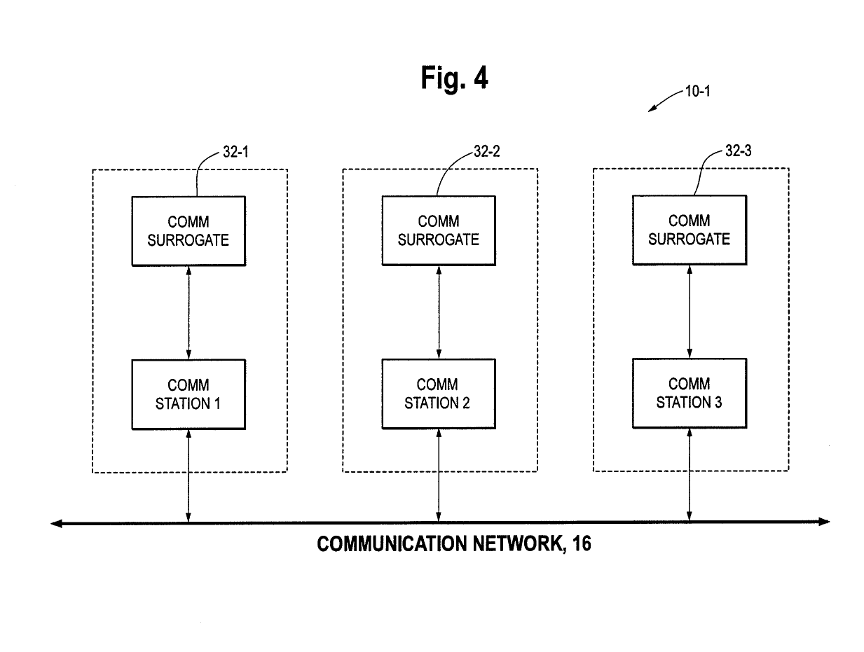

FIG. 4 illustrates a multi-station configuration 10-1 wherein a plurality of communication stations such as 1,2 or 3 can be in communication via network 16 with the base station 12. Instrumented surrogates 32-1, 32-2 and -3, corresponding to the surrogate 32, can be associated with each of the communication stations.

Automated testing of the system 10-1 can be carried out via communications network 16 using each of the surrogates 32-1, -2, -3 . . . -n.

Statistics can be gathered and used to diagnose stability as well as any transmission problems, for example dropped packets. As noted above, information pertaining to signal quality and integrity at respective stations such as stations 1, 2 or 3 . . . n can communicate via network 16 with one another as well as with a respective base station, such as base station 12. No separate or special communications port is required.

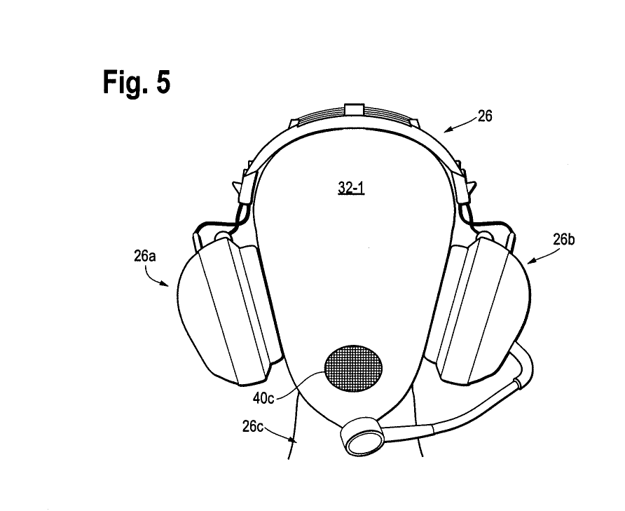

FIG. 5 illustrates a particular instrumented surrogate or mannequin 32-1 which carries a headset 26 which could be part of a helmet.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A sound evaluating system comprising:
a mannequin which carries first and second spaced apart microphones, and an audio output transducer spaced apart from the microphones but therebetween; and
control circuits coupled to the microphones and transducer, the control circuits are responsive to audio signals received at the microphones and provide an audio output to be emitted by the transducer.

2. A system as in claim 1 which includes a third microphone, displaced from the mannequin, which receives audio signals emitted by the output transducer.

3. A system as in claim 2 where the received audio signals are coupled to local communications circuits for evaluation and adjustment.

4. A system as in claim 1 where the control circuits include tone decoder circuits coupled to at least one of the microphones.

5. A system as in claim 4 where the control circuits include measurement electronics coupled to the at least one microphone.

6. A system as in claim 5 where the control circuits include tone generation circuitry coupled to the output transducer.

7. A system as in claim 6 where the control circuits include a programmable processor and associated test software.

8. A system as in claim 6 where at least the programmable processor and some of the test software are located adjacent to the mannequin.

9. A system as in claim 8 which includes tone decoder circuitry coupled between at least one of the microphones and the processor.

10. A system as in claim 9 which includes measurement electronics coupled to the tone decoder circuitry and the processor.

11. A system as in claim 10 which includes a tone generator coupled between the processor and the audio output transducer.

12. A system as in claim 11 which includes a mechanical actuator coupled to the processor.

13. A system as in claim 12 where the processor and software carry out a communications system test process which includes responding to received test tones and generating output test tones.

14. A system as in claim 13 which includes processor generated control signals to energize the actuator in conjunction with generating the output test tones.

15. A method of testing performance of a device such as a headset or helmet comprising:
establishing at least one audio receiving location and at least one output audio emitting location;
positioning a device to be tested adjacent to the locations;
emitting test audio from the device;
sensing the test audio at the audio receiving location;
converting the test audio to a first electrical signal;
transmitting a representation of the electrical signal to an evaluation location;
emitting selected audio at the output audio emitting location;
sensing the emitted selected audio at the device;
converting the emitted selected audio to a second electrical signal; and
transmitting a representation of the second electrical signal to the evaluation location.

16. A method as in claim 15 which includes, responsive to the transmitted representation of the first electrical signal, carrying out adjustments associated with the test audio.

17. A method as in claim 16 which includes, responsive to the transmitted representation of the second electrical signal, carrying out adjustments associated with the selected audio.

18. A method as in claim 17 which includes actuating a push-to-talk mechanism in connection with emitting the selected audio.

19. A method as in claim 17 which includes displaying indicia associated with the test audio.

20. A method as in claim 19 where the indicia are displayed adjacent to the audio receiving location.

21. A method as in claim 15 which includes transmitting commands to the device from the evaluation location.

22. A method as in claim 21 where transmitting commands include generating electrical signals indicative of selected control tones and transmitting the signal to the device.

23. A method as in claim 22 which includes receiving the signals at the device and decoding the respective commands.

24. A method as in claim 15 which includes establishing a plurality of spaced apart audio receiving locations, with an output audio emitting location positioned adjacent to each audio receiving location;
coupling each audio receiving location to an evaluation location;
positioning a device to be tested adjacent to each of the locations;
emitting test audio from the devices;
sensing the test audio at the audio receiving locations;
converting the test audio to electrical signals;
transmitting representations of the electrical signals to the evaluation location;
emitting selected audio at the output audio emitting locations;
sensing the emitted selected audio at the devices;
converting the emitted selected audio to other electrical signals; and
transmitting representations of the other electrical signals to the evaluation location.
